(19) United States
(12) Patent Application Publication
(10) Pub. No.: US 2023/0385791 A1
(43) Pub. Date: Nov. 30, 2023

(54) Experience Based NFT Marketplace for Digital Assets

(71) Applicant: Google LLC, Mountain View, CA (US)

(72) Inventor: Krishna Chytanya Ayyagari, Dublin, CA (US)

(21) Appl. No.: 18/077,624

(22) Filed: Dec. 8, 2022

Related U.S. Application Data
(60) Provisional application No. 63/345,062, filed on May 24, 2022.

(51) Int. Cl. G06Q 20/12; G06Q 20/38

(52) U.S. Cl. CPC G06Q 20/1235; G06Q 20/389

(57) ABSTRACT

Systems and methods for providing embedded purchase links for non-fungible tokens can leverage the generation of software packets. The systems and methods can obtain digital asset data associated with a non-fungible token. The digital asset data can be processed to generate a software packet with a purchase link and callout data. The purchase link can be selected to instruct an application programming interface to record a transaction on a blockchain. The callout data can be recognizable by a search engine for surfacing the purchase link in generated search results associated with the non-fungible token.

### RELATED APPLICATIONS

This application claims priority to and the benefit of U.S. Provisional Patent Application No. 63/345,062, filed May 24, 2022. U.S. Provisional Patent Application No. 63/345,062 is hereby incorporated by reference in its entirety.

### FIELD

The present disclosure relates generally to providing a software packet for generating an embedded non-fungible token purchase interface. More particularly, the present disclosure relates to generating a software packet that includes a purchase link for embedding a purchasing interface in webpages of various types.

### BACKGROUND

With people being online for a large portion of their life and the need for a new iteration of the world wide web based on blockchain (referred to as web3) growing stronger, digital assets are becoming the future of the capital markets. Traditional non-fungible token marketplaces can fail to provide information that can be utilized by consumers for informed purchasing. Similarly, looking at the blockchain data can provide little insight into the marketability of a particular non-fungible token. Additionally, users with limited knowledge of the field of non-fungible tokens may have difficulty finding and researching non-fungible tokens to purchase. User preferences including taste, marketability, and source can be hard to decipher. Moreover, marketplaces can struggle to preview non-image digital assets that are provided for sale.

Additionally, non-fungible token marketplaces can be heavily regulated, and the marketplaces may receive a percentage of sales that will not go to the owner at the time of sale. However, the marketplace can control how the digital asset is viewed and what information is provided on the purchase page. The preview and other information may not provide the information needed for proper informed purchasing.

### SUMMARY

Aspects and advantages of embodiments of the present disclosure will be set forth in part in the following description, or can be learned from the description, or can be learned through practice of the embodiments.

One example aspect of the present disclosure is directed to a computing system. The system can include one or more processors and one or more non-transitory computer-readable media that collectively store instructions that, when executed by the one or more processors, cause the computing system to perform operations. The operations can include obtaining digital asset data. In some implementations, the digital asset data can be descriptive of a digital asset and a non-fungible token for the digital asset. The operations can include generating a purchase link for the digital asset based at least in part on the digital asset data. The purchase link can be configured to be embedded in a webpage to enable a purchase event to occur for the digital asset within the webpage. The operations can include providing the purchase link as an output.

Another example aspect of the present disclosure is directed to a computer-implemented method. The method can include obtaining, by a computing system including one or more processors, a purchase link and a digital asset from a first user. The purchase link can be configured to be embedded in a webpage to enable a purchase event to occur for the digital asset within the webpage. The method can include generating, by the computing system, a generated webpage. In some implementations, the generated webpage can include the digital asset and an interactive purchase element, and the interactive purchase element can be associated with the purchase link. The method can include providing, by the computing system, the generated webpage to a second user and receiving, by the computing system, a selection of the interactive purchase element from the second user. The method can include adjusting, by the computing system, a blockchain ledger based at least in part on the selection of the interactive purchase element from the second user.

Another example aspect of the present disclosure is directed to one or more non-transitory computer-readable media that collectively store instructions that, when executed by one or more computing devices, cause the one or more computing devices to perform operations. The operations can include obtaining a search query via an input field of a search engine. The operations can include obtaining a plurality of search results based on the search query. The plurality of search results can include one or more digital asset search results descriptive of a digital asset. The digital asset can be associated with a non-fungible token on a blockchain. The operations can include providing a search results page in a search user interface of the search engine. In some implementations, the search results page can include the one or more digital asset search results with an interactive purchase element. The interactive purchase element can be associated with a purchase link, and the purchase link can be embedded in the search results page to enable a purchase event to occur for the digital asset within the search results page. The operations can include receiving a selection of the interactive purchase element and adjusting a blockchain ledger based at least in part on the selection of the interactive purchase element.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs providing an embedded purchase link according to example embodiments of the present disclosure.

FIG. 1B depicts a block diagram of an example computing device that performs providing an embedded purchase link according to example embodiments of the present disclosure.

FIG. 2 depicts a block diagram of example computing system interactions according to example embodiments of the present disclosure.

FIG. 3 depicts an illustration of an example webpage according to example embodiments of the present disclosure.

FIG. 4 depicts an illustration of an example search results page according to example embodiments of the present disclosure.

FIG. 5 depicts a block diagram of example computing system interactions according to example embodiments of the present disclosure.

FIG. 6 depicts a flow chart diagram of an example method to perform generating and providing a purchase link according to example embodiments of the present disclosure.

FIG. 7 depicts a flow chart diagram of an example method to perform generating a webpage and facilitating a transaction according to example embodiments of the present disclosure.

FIG. 8 depicts a flow chart diagram of an example method to perform providing a search results page according to example embodiments of the present disclosure.

Reference numerals that are repeated across plural figures are intended to identify the same features in various implementations.

### DETAILED DESCRIPTION

### Overview

Generally, the present disclosure is directed to providing and utilizing an embedded link for purchasing digital assets within webpages. The systems and methods disclosed herein can leverage the embedded link to enable the purchasing of the digital assets without having to navigate a digital asset marketplace. The systems and methods can allow for creators to post their digital assets for display on their personal webpages (e.g., their personal blog) with a purchase interface provided without navigating to a digital asset marketplace.

The systems and methods disclosed herein can include obtaining digital asset data. In some implementations, the digital asset data can be descriptive of a digital asset and a non-fungible token for the digital asset. A purchase link for the digital asset can be generated based at least in part on the digital asset data. The purchase link can be configured to be embedded in a webpage to enable a purchase event to occur for the digital asset within the webpage. The purchase link can be provided as an output.

In some implementations, the systems and methods can include obtaining digital asset data. The digital asset data can be descriptive of a digital asset and a non-fungible token for the digital asset. In some implementations, the non-fungible token can be minted on the blockchain. The digital asset can include an image, a video, audio, text data, latent encoding data, a domain, augmented-reality assets, and/or virtual-reality assets. The non-fungible token can include script data that is descriptive of a reference location for the digital asset. In some implementations, the non-fungible token can include embedded code descriptive of the digital asset. The non-fungible token can be associated with a smart contract and/or one or more electronic ledgers. The smart contract can automatically cause an action to occur in response to a triggering event. For example, currency can be exchanged in response to a transaction being recorded. The one or more electronic ledgers can record a ground truth of transaction events associated with the digital asset.

A purchase link for the digital asset can be generated based at least in part on the digital asset data. The purchase link can be configured to be embedded in a webpage to enable a purchase event to occur for the digital asset within the webpage. The webpage can include one or more user interfaces and may be a blog page, a news page, a social media page, etc.

The purchase link can then be provided as an output. In some implementations, the purchase link can be provided in a software packet. The software packet can include script for embedding the purchase link into the webpage. The software packet can include callout data that can be recognized by a search engine. The search engine can then provide a non-fungible token indicator with the webpage's search result.

In some implementations, the systems and methods can include generating script data. The script data can include the purchase link and callout data. Additionally and/or alternatively, the script data can be configured to be embedded in webpage code to embed the purchase link. The callout data can be discoverable by one or more search engines. In some implementations, the callout data can indicate the webpage includes a digital asset for purchase. The callout data can be configured to be processed by the one or more search engines to prompt the purchase link to be provided with a search result.

Alternatively and/or additionally, the systems and methods can include receiving input data (e.g., data descriptive of one or more selections to a user interface). The input data can be associated with a selection of the purchase link. The systems and methods can include determining the input data is associated with a purchase request. A transaction can then be recorded on a blockchain. Recording a transaction on the blockchain can include sending transaction instructions to a blockchain application programming interface to interact with a blockchain computing system associated with the blockchain.

In some implementations, the systems and methods can include receiving search input data. The search input data can include one or more search terms. A plurality of search results associated with the one or more search terms can be determined. The systems and methods can include determining one or more particular search results of the plurality of search results are associated with one or more respective purchase links. A search results page can then be provided. The search results page can include the one or more particular search results with one or more interactive elements. In some implementations, the one or more interactive elements can be associated with the one or more respective purchase links.

Alternatively and/or additionally, the systems and methods can include receiving search input data. The search input data can include one or more input images. The systems and methods can include determining a plurality of search results associated with the one or more input images. In some implementations, the systems and methods can include determining one or more particular search results of the plurality of search results are associated with one or more respective purchase links. A search results page can then be provided. The search results page can include the one or more particular search results with one or more interactive elements. In some implementations, the one or more interactive elements can be associated with the one or more respective purchase links.

Alternatively and/or additionally, a recipient computing system can obtain a purchase link and a digital asset from a first user. The purchase link can be configured to be embedded in a webpage to enable a purchase event to occur for the digital asset within the webpage. The systems and methods can generate a generated webpage. The generated webpage can include the digital asset and an interactive purchase element. In some implementations, the interactive purchase element can be associated with the purchase link. The systems and methods can include providing the generated webpage to a second user. A selection of the interactive purchase element can be received from the second user. A blockchain ledger can be adjusted based at least in part on the selection of the interactive purchase element from the second user.

In some implementations, a purchase link and a digital asset can be obtained from a first user. The purchase link can be configured to be embedded in a webpage to enable a purchase event to occur for the digital asset within the webpage.

The systems and methods can then generate a generated webpage (e.g., a blog page, an article page, etc.). The generated webpage can include the digital asset and an interactive purchase element. In some implementations, the interactive purchase element can be associated with the purchase link. The digital asset can include an image. Additionally and/or alternatively, the generated webpage can include a user interface that displays the image and the interactive purchase element. The interactive element can be adjacent to the image in the user interface.

The generated webpage can be provided to a second user. The generated webpage can be provided to the second user via a network. In some implementations, the generated webpage can be stored by a server computing system to be accessed by a plurality of second users via a web browser. In some implementations, the generated webpage can be provided in a user interface of a web browser application.

A selection of the interactive purchase element can be received from the second user. The selection can be determined from received input data and may be determined based on a mouse selection or touch selection proximate to an interactive purchase element displayed in the user interface.

A blockchain ledger can then be adjusted based at least in part on the selection of the interactive purchase element from the second user. The blockchain ledger can be adjusted with one or more application programming interfaces that automatically interact with the blockchain ledger in response to the selection. In some implementations, the blockchain ledger can be associated with a blockchain computing system that stores a non-fungible token associated with the digital asset.

In some implementations, the systems and methods disclosed herein can be utilized to identify digital assets associated with non-fungible tokens and provide purchase links for the digital assets in a search results page. For example, the systems and methods can include obtaining a search query via an input field of a search engine. The systems and methods can obtain a plurality of search results based on the search query. In some implementations, the plurality of search results can include one or more digital asset search results descriptive of a digital asset. The digital asset can be associated with a non-fungible token on a blockchain. A search results page can then be provided in a search user interface of the search engine. The search results page can include the one or more digital asset search results with an interactive purchase element. In some implementations, the interactive purchase element can be associated with a purchase link. The purchase link can be embedded in the search results page to enable a purchase event to occur for the digital asset within the search results page. The systems and methods can receive a selection of the interactive purchase element. In some implementations, the systems and methods can include adjusting a blockchain ledger based at least in part on the selection of the interactive purchase element.

The systems and methods can include obtaining a search query via an input field of a search engine. The search query can be obtained from a user computing system. The input field can include an input box in a search engine user interface.

A plurality of search results can then be obtained based on the search query. The plurality of search results can include one or more digital asset search results descriptive of a digital asset. In some implementations, the digital asset can be associated with a non-fungible token on a blockchain. The one or more digital asset search results can be determined based on callout data embedded into a specific webpage associated with the one or more digital asset search results.

A search results page can be provided in a search user interface of the search engine. The search results page can include the one or more digital asset search results with an interactive purchase element. In some implementations, the interactive purchase element can be associated with a purchase link. The purchase link can be embedded in the search results page to enable a purchase event to occur for the digital asset within the search results page. Additionally and/or alternatively, the systems and methods can include generating the interactive purchase element based in part on the callout data. The search results page can include an image search results page. In some implementations, the image search results page can provide a plurality of image search results for display. The interactive purchase element can be provided for display adjacent to a particular image search result descriptive of the digital asset.

A selection of the interactive purchase element can be received. The selection can be determined by processing input data from the user computing system. The input data can be descriptive of the user making a touch compression proximate to the interactive purchase element.

A blockchain ledger can be adjusted based at least in part on the selection of the interactive purchase element. The blockchain ledger can be associated with a blockchain computing system. In some implementations, the blockchain ledger can include a plurality of blocks that are associated with a plurality of transactions associated with the digital asset.

In some implementations, the systems and methods can be utilized to link and consolidate a user's digital assets in a single console that stores and/or displays all of a user's non-fungible tokens. The non-fungible tokens can then be published on a user's webpage(s).

Additionally and/or alternatively, the systems and methods can be utilized to provide non-fungible tokens without having to post the non-fungible token on a marketplace; therefore, marketplace fees can be eliminated.

In some implementations, a user can post a video or other media content item on a media hosting platform (e.g., a video hosting platform). The user can then mint at least a portion of the media content item on a blockchain. The user can then request a software packet (e.g., a software packet with a purchase link and callout data) for the minted non-fungible token. The software packet can then be utilized to post a non-fungible token purchase widget on a blog, on a user profile page of the hosting platform, or on any other webpage. For example, a user can clip a portion of a posted video, mint the clipped video, and post the non-fungible token associated with the video clip for sale on the user's profile page for that very video hosting platform that hosts the posted video. Therefore, a fan of the user can easily find and purchase non-fungible tokens that are relevant to them. The posting can additionally provide context and the information wanted by a potential purchaser before purchase.

Additionally and/or alternatively, the software packet can include a list of previous transactions associated with the non-fungible token. The list of previous transactions can be tracked and stored by a server computing system. Alternatively and/or additionally, the list of previous transactions can be determined by one or more methods. The list of previous transactions can then be provided for display in response to one or more interactions with the purchase user interface.

In some implementations, the systems and methods disclosed herein can enable a singular non-fungible-token profile picture across platforms via ease of authentication.

In some implementations, the systems and methods disclosed herein can provide creator credibility. The creator credibility can be provided by easily providing their works for sale on their personal webpages.

Additionally and/or alternatively, the systems and methods can allow streamlined experiences and/or consolidated experiences for image platforms, video platforms, search platforms, and/or market platforms. The systems and methods can enable posting a non-fungible token for sale on a plurality of webpage types. The posted non-fungible token can then be found and provided for display by search engines due to callout data in the software packet. The callout data can indicate a webpage or specific media content item is associated with a non-fungible token. Additionally and/or alternatively, the callout data can provide details related to the type of digital asset associated with the non-fungible token.

The software packet can include an application programming interface. The application programming interface can be configured to interact with a blockchain computing system to adjust one or more blockchain ledgers for the particular non-fungible token associated with the purchase link. For example, the application programming interface can be instructed to complete an action in response to an interaction with an interactive purchase element associated with the purchase link. The application programming interface can add the transaction data to a blockchain. In some implementations, the application programming interface can generate and provide proof of work of a transaction to a blockchain.

The systems and methods disclosed herein can allow for the purchasing of a non-fungible token from any form of webpage without navigating to a new webpage. For example, a user can embed the software packet into a blog webpage, a business webpage, or any webpage to generate an embedded widget with one-click purchase capability.

A non-fungible token (NFT) can be a certificate of authenticity of a digital asset. Non-fungible tokens can be non-interchangeable thus making their worth dependent on the price anyone is willing to pay. Non-fungible tokens can be minted on blockchains. Non-fungible tokens can enable new and more decentralized actors to use programmability to create new value exchanges that transform industry structures. Additionally, in some implementations, non-fungible tokens can be minted (or recorded) on a blockchain to ensure scarcity and authenticity of the ownership of a digital asset.

In some implementations, the systems and methods disclosed herein can embed selling and buying options of digital assets across different products that attract internet visitors based on their experience or necessity rather than visiting a marketplace. The systems and methods disclosed herein can include a portal where users can view their digital assets. Additionally and/or alternatively, the users can sell and buy the digital assets on different platforms/experiences like blogs, photo sharing apps, search results, etc.

The systems and methods can utilize an experience based world wide web where any user over the internet can one-click purchase a digital asset while browsing a webpage. All digital assets, if tagged and announced as a digital asset for sale by the original content creator, may be available for a one-click purchase to everyone on the internet.

A content creator can have a one-click purchase link generated. The creator can then embed that link while publishing a blog or a website along with the content. Such publication can allow for a search engine to surface non-fungible tokens associated with the content creator in response to a search of the content creator's name or works. Additionally and/or alternatively, the purchase link can be surfaced in response to the search.

An ecosystem of products like blogs, search engines that index data optimized for search engines by content creators, and online advertisement agencies, can benefit from the embedded purchase interfaces for non-fungible tokens. Every content creator can create a unique one-click purchase, which can be embedded in all ecosystems of products in which the content can be published for users' consumption.

In some implementations, the systems and methods disclosed herein can be utilized to provide blogs as an experience, search results as an experience, website real estate as a digital asset, online video sharing platform as an experience, and/or social media platform as an experience.

For example, an author can write a blog about the author's travel experience and can embed images or documents (which can be digital assets) the author owned and created. If the author has a link to buy digital assets along with every digital asset the author created, then the users visiting the blog can buy those digital assets in one-click.

Users looking for an image can search a search engine and can find a lot of images. The users can then filter images with a special search filter like “images with NFTs available.” All images that are published over the internet can be announced as “NFT available” with a special SEO tag that can be read by searching engines while indexing those images.

Website owners can place advertisements wherever they want and work with digital advertising agencies to place advertisements in the areas. In some implementations, real estate of websites can be sold as NFTs for users to buy them in one-click using the one-click URL created.

On video sharing platforms, any user can choose to sell the video as a NFT while uploading that video or update published videos with one-click purchase URLs generated. Additionally and/or alternatively, any comments or discussions on any experiences can be sold as NFTs with one-click purchase URLs generated.

Having authenticated digital assets, for example images, as profile photos can be a great way to verify user profiles. The profile images can create a community. For example, if all assets are created from a movie fan blog, then they can be part of a community, and this can lead to more loyalty to the brand from which these digital assets may be purchased from.

The systems and methods of the present disclosure provide a number of technical effects and benefits. As one example, the system and methods can provide systems and methods for facilitating the generation of a purchase link for embedding in a webpage. For example, the systems and methods disclosed herein can facilitate the generation and use of a software packet that can be embedded into the code of a webpage to generate an interactive purchase interface in a webpage of various types.

Another technical benefit of the systems and methods of the present disclosure is the ability to leverage callout data embedded in a webpage to discover non-fungible tokens and surface the purchase link in the generated search results. For example, the systems and methods disclosed herein can determine a search result has callout data. The determination can cause the search engine to extract the purchase link to generate an interactive search element that can be provided and interacted with in the search results page.

Another technical benefit of the systems and methods of the present disclosure is the ability to leverage a generated software packet to embed a purchase element in a content creator's webpage. The content creator's webpage can provide information on the creator and the asset for sale.

Another example of technical effect and benefit relates to improved computational efficiency and improvements in the functioning of a computing system. For example, the systems and methods disclosed herein can leverage callout data to surface the purchase links for the non-fungible tokens can greatly reduce the computational power to crawl each webpage to extract data that may or may not be related to a non-fungible token. Additionally, the systems and methods disclosed herein can reduce the computational power utilized by a user when attempting to obtain data on a digital asset and then purchase the digital asset.

With reference now to the Figures, example embodiments of the present disclosure will be discussed in further detail.

### Example Devices and Systems

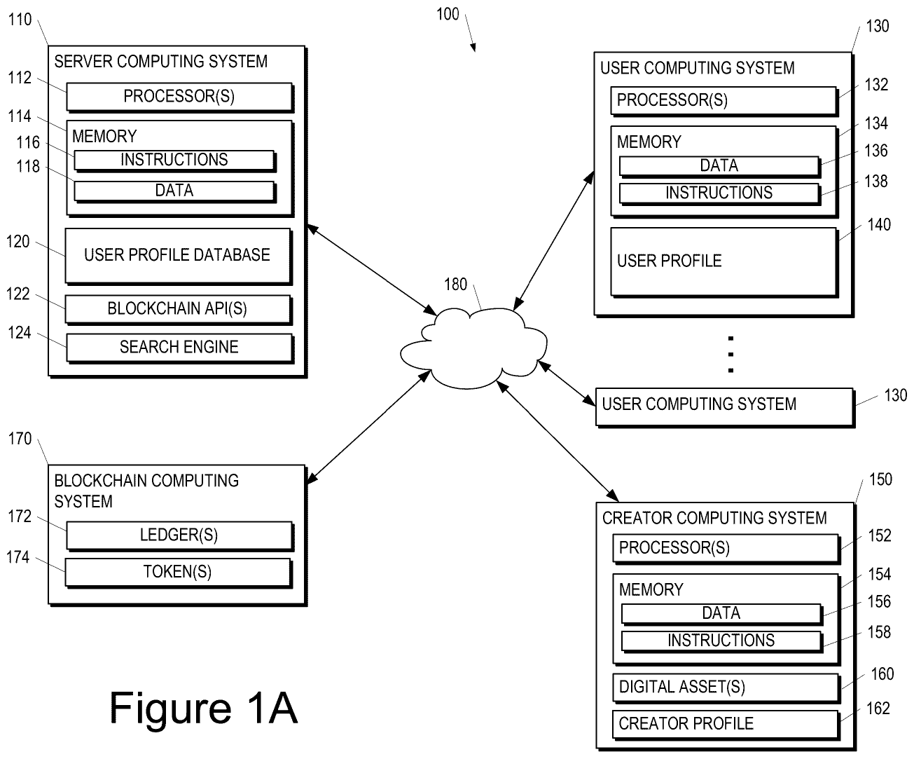

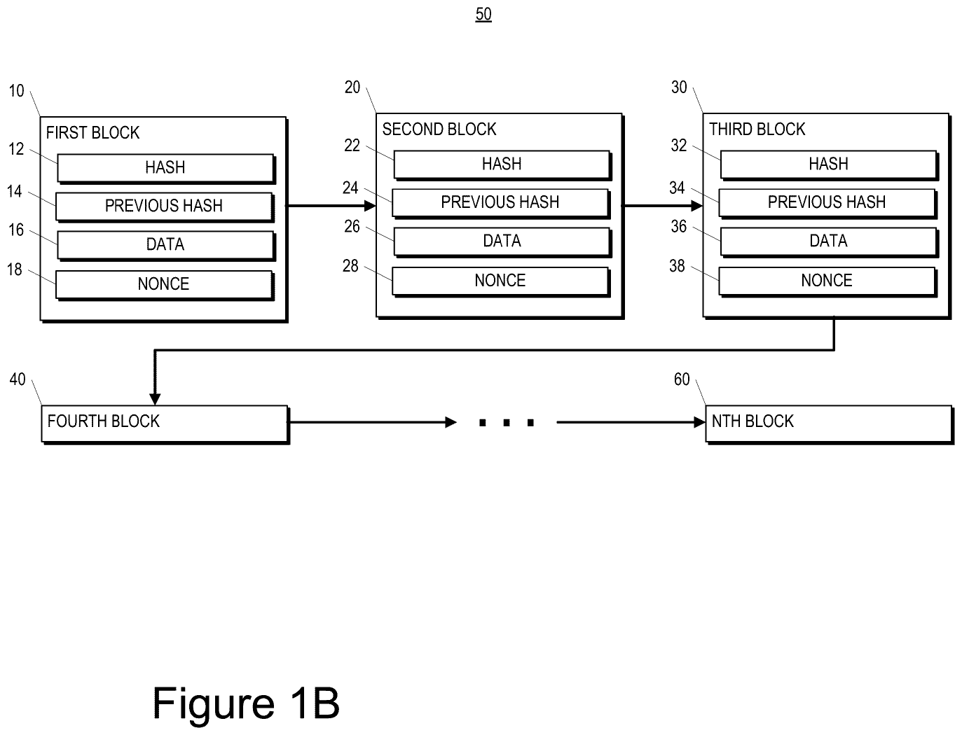

FIG. 1A depicts a block diagram of an example computing system 100 that performs embedded purchase link generation according to example embodiments of the present disclosure. The system 100 includes a user computing system 130, a server computing system 110, a creator computing system 150, and a blockchain computing system 170 that are communicatively coupled over a network 180.

The user computing system 130 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the user computing system 130 to perform operations.

The user computing system 130 can also include one or more user input components that receive user input. For example, the user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 110 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 118 and instructions 116 which are executed by the processor 112 to cause the server computing system 110 to perform operations.

In some implementations, the server computing system 110 includes or is otherwise implemented by one or more server computing devices. In instances in which the server computing system 110 includes plural server computing devices, such server computing devices can operate according to sequential computing architectures, parallel computing architectures, or some combination thereof.

The blockchain computing system 170 includes one or more processors and a memory. The one or more processors can be any suitable processing device (e.g., a processor core, a microprocessor, an ASIC, a FPGA, a controller, a microcontroller, etc.) and can be one processor or a plurality of processors that are operatively connected. The memory can include one or more non-transitory computer-readable storage mediums, such as RAM, ROM, EEPROM, EPROM, flash memory devices, magnetic disks, etc., and combinations thereof. The memory can store data and instructions which are executed by the processor to cause the blockchain computing system 170 to perform operations. In some implementations, the blockchain computing system 170 includes or is otherwise implemented by one or more server computing devices.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The computing system 100 can include a number of applications (e.g., applications 1 through N). Each application can be in communication with a central intelligence layer. Example applications can include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can communicate with a central device data layer. The central device data layer can be a centralized repository of data for the computing system 100. In some implementations, the central device data layer can communicate with a number of other components of the computing device, such as, for example, one or more sensors, a context manager, a device state component, and/or additional components. In some implementations, the central device data layer can communicate with each device component using an API (e.g., a private API).

Additionally and/or alternatively, FIG. 1A depicts an exemplary computing system 100 that can be used to implement embedded purchase link generation according to aspects of the present disclosure. The system 100 has a user-server architecture that includes a server 110 that communicates with one or more user computing systems 130 over a network 180. However, the present disclosure can be implemented using other suitable architectures, which can include any number of computing systems communicating over a network 180.

The system 100 includes a server 110, such as, for example, a web server. The server 110 can be one or more computing devices that are implemented as a parallel computing system and/or a distributed computing system. In particular, multiple computing devices can act together as a single server 110. The server 110 can have one or more processor(s) 112 and a memory 114. The server 110 can also include a network interface used to communicate with one or more remote computing devices (e.g., user devices) 130 over a network 180.

The processor(s) 112 can be any suitable processing device, such as a microprocessor, microcontroller, integrated circuit, or other suitable processing device. The memory 114 can include any suitable computing system or media, including, but not limited to, non-transitory computer-readable media, RAM, ROM, hard drives, flash drives, or other memory devices. The memory 114 can store information accessible by processor(s) 112, including instructions 116 that can be executed by processor(s) 112. The instructions 116 can be any set of instructions that when executed by the processor(s) 112, cause the processor(s) 112 to provide desired functionality.

In particular, the instructions 116 can be executed by the processor(s) 112 to implement embedded purchase link generation. The user profile database 120 can be configured to store a plurality of user profiles associated with a plurality of users utilizing one or more user computing systems 130. In some implementations, the user profile database 120 can be configured to be utilized for facilitating one or more interactions. The facilitation of the one or more interactions can involve the use of a blockchain application programming interface (API) 122 to send data to and receive data from a blockchain computing system 170. For example, a server computing system 110 can utilize the blockchain API 122 to update one or more ledgers 172 of the blockchain computing system 170. The one or more ledgers 172 can be associated with one or more tokens 174. The one or more tokens 174 can include one or more non-fungible tokens, which can include scripts associated with a digital asset (e.g., image data, video data, text data, latent encoding data, domain data, audio data, augmented-reality asset rendering data, and/or virtual-reality asset rendering data). In particular, the script can reference a specific digital asset that is provided for sale. The digital asset can include image data, text data, video data, latent encoding data, a domain name, a virtual property, an augmented-reality asset, a virtual-reality asset (e.g., a virtual-reality environment and/or a virtual-reality object for interaction in an environment), a smart contract, a physical item authentication, etc. In some implementations, the one or more ledgers 172 can be associated with cryptocurrency that can be utilized to make transactions in a physical marketplace and/or a virtual marketplace.

It will be appreciated that the term “element” can refer to computer logic utilized to provide desired functionality. Thus, any element, function, and/or instructions can be implemented in hardware, application specific circuits, firmware and/or software controlling a general purpose processor. In one implementation, the elements or functions are program code files stored on the storage device, loaded into memory and executed by a processor or can be provided from computer program products, for example computer executable instructions, that are stored in a tangible computer-readable storage medium such as RAM, hard disk or optical or magnetic media.

Memory 114 can also include data 118 that can be retrieved, manipulated, created, or stored by processor(s) 112. The data 118 can include search result data, ranking data, image data (e.g., digital maps, satellite images, aerial photographs, street-level photographs, synthetic models, paintings, personal images, portraits, etc.), video data, audio data, text data (e.g., books, articles, blogs, poems, etc.), latent encoding data, blockchain address data, tables, vector data (e.g., vector representations of roads, parcels, buildings, etc.), point of interest data (e.g., locales such as islands, cities, restaurants, hospitals, parks, hotels, and schools), or other data or related information. As an example, the data 118 can be used to access information and data associated with a specific digital asset, website, search result, blockchain, etc.

The data 118 can be stored in one or more databases. The one or more databases can be connected to the server 110 by a high bandwidth LAN or WAN, or can also be connected to server 110 through network 180. The one or more databases can be split up so that they are located in multiple locales.

The server 110 can exchange data with one or more user computing systems 130 over the network 180. Although two user computing systems 130 are illustrated in FIG. 1A, any number of user computing systems 130 can be connected to the server 110 over the network 180. The user computing systems 130 can be any suitable type of computing device, such as a general purpose computer, special purpose computer, navigational device, laptop, desktop, integrated circuit, mobile device, smartphone, tablet, wearable-computing devices, a display with one or more processors coupled thereto and/or embedded therein, or other suitable computing device. Further, the user computing system 130 can be multiple computing devices acting together to perform operations or computing actions.

Similar to server 110, a user computing system 130 can include a processor(s) 132 and a memory 134. The memory 134 can store information accessible by processor(s) 132, including instructions that can be executed by processor(s) and data. As an example, memory 134 can store data 136 and instructions 138.

Instructions 138 can provide instructions for implementing a browser, a non-fungible token purchase, and/or a plurality of other functions. In particular, the user of user computing system 130 can exchange data with server 110 by using the browser to visit a website accessible at a particular web-address. The embedded purchase link generation of the present disclosure can be provided as an element of a user interface of a website and/or application.

The data 136 can include data related to running a specialized application on the user computing system 130. In particular, the specialized application can be used to exchange data with server 110 over the network 160. The data 136 can include user-device-readable code for providing and implementing aspects of the present disclosure. Additionally and/or alternatively, the data 136 can include data related to previously inputted or received data. For example, the data 136 can include data related to past occurrences of the special application.

The user computing system 130 can include various user input devices for receiving information from a user, such as a touch screen, touch pad, data entry keys, speakers, mouse, motion sensor, and/or a microphone suitable for voice recognition. Further, the user computing system 130 can have a display for presenting information, such as a user interface, displaying a digital asset, displaying pop-ups or application elements displayed in an interface, and/or other forms of information.

The user computing system 130 can also include a user profile 140 that can be used to identify a user of the user computing system 130. The user profile 140 can be optionally used by the user to make one or more transactions which can then be recorded on one or more ledgers 172 of the blockchain computing system 170. The user profile 140 can be descriptive of user information, which can include identification numbers and/or payment account information. For example, the user profile 140 can include data associated with a crypto wallet, which may be linked to a browser application via an application extension and/or embedding.

The user computing system 130 can further include a graphics processing unit. Graphics processing unit can be used by processor 132 to embedded purchase link generation. In some embodiments, the user computing system 130 performs any and all software packet generation, software packet transmission, software packet embedding, and/or application programming interface configuring.

The user computing system 130 can include a network interface for communicating with a server 110 over a network 180. Network interface can include any components or configuration suitable for communication with server 110 over network 180, including, for example, one or more ports, transmitters, wireless cards, controllers, physical layer components, or other items for communication according to any currently known or future developed communications protocol or technology.

The network 180 can be any type of communications network, such as a local area network (e.g., intranet), wide area network (e.g., Internet), or some combination thereof. The network 180 can also include a direct connection between a client device 130 and the server 110. In general, communication between the server 110 and a client device 130 can be carried via network interface using any type of wired and/or wireless connection, using a variety of communication protocols (e.g., TCP/IP, HTTP), encodings or formats (e.g., HTML, XML), and/or protection schemes (e.g., VPN, secure HTTP, SSL).

In some implementations, the exemplary computing system 100 can include one or more creator computing systems 150. The one or more creator computing systems 150 can be utilized for generating images, videos, prose, poetry, audio, etc., which can then be provided for sale. The one or more creator computing systems 150 can include one or more processors 152, which can be utilized to execute one or more operations to implement the systems and methods disclosed herein. The one or more creator computing systems 150 can include one or more memory components 154, which can be utilized to store data 156 and one or more instructions 158. The data 156 can include data related to one or more applications, one or more media datasets, etc. The instructions 158 can include one or more operations for implementing the systems and methods disclosed herein.

The one or more creator computing systems 150 can store data associated with one or more digital assets 160 and/or one or more creator profiles 162. The one or more digital assets 160 can include text data, image data, video data, audio data, latent encoding data, domain data, or a variety of other data formats. The one or more creator profiles 162 can include information associated with one or more “creators” of the one or more digital assets 160. The one or more creator profiles 162 can include identification data, transaction data, and/or crypto wallet data.

Additionally and/or alternatively, the exemplary computing system 100 can include one or more blockchain computing systems 170. The one or more blockchain computing systems 170 can include a plurality of computing devices being utilized for decentralized data storage, such that a plurality of “blocks” can be distributed throughout a network of computing devices to provide a secure system for data storage, which can include one or more ledgers 172 and one or more tokens 174. In some implementations, each of the one or more tokens 174 can be associated with at least a portion of the one or more ledgers 172.

Blockchain can refer to a system configured to securely record information. The blockchain can include a decentralized system that can render changing information extremely difficult. The blockchain can include a digital ledger of transactions that can be duplicated and distributed across a network of computing systems. Each block in the chain can include a number of transactions. When a new transaction occurs on the blockchain, a record of that transaction can be added to every computing device's ledger. The blockchain can be utilized to track the exchange of currency and/or digital assets via the recording of transactions on the digital ledger, which can be propagated throughout the decentralized system. The currency exchanged and tracked via the blockchain computing system 170 can be referred to as cryptocurrency.

The tokens 174 can include one or more non-fungible tokens. The non-fungible tokens can be minted on a blockchain associated with the blockchain computing system 170. A non-fungible token (NFT) can be a certificate of authenticity of a digital asset. NFTs can be non-interchangeable thus making their worth depend on the price anyone may be willing to pay for the asset. NFTs can be printed on blockchains such that their scarcity and authenticity can be maintained. A digital asset can be defined as anything that is stored digitally and can be uniquely identifiable that organizations can use to realize value. Examples of digital assets can include a tweet, a social media comment, documents, audio, images, videos, logos, website domains, slide presentations, spreadsheets, CSS files and formats, executable code, and/or websites.

FIG. 1B depicts a block diagram of an example blockchain 50 that may be utilized by the blockchain computing system 170 of the exemplary computing system 100 of FIG. 1A. The example blockchain 50 can include a plurality of blocks that can be utilized to store data with one or more cryptographic features. The blockchain 50 can be stored on a decentralized computing system comprising a plurality of computing devices. The blockchain 50 can be a public blockchain (e.g., a blockchain that is open without access restrictions such that anyone with an internet access can send transactions or validate transactions as part of the decentralized, distributed system), a private blockchain (e.g., a blockchain that provides access based on permissions set by network administrators), or a hybrid blockchain (e.g., a blockchain with a combination of blocks with no restrictions and blocks with restrictions). The blockchain 50 can include proof of work features that can include one or more cryptographic forms of proof. The proof of work can be provided upon a request to update the blockchain 50 (e.g., a request to update the ledgers based on a new transaction). The proof of work can convey that a certain device or group of devices have performed a certain amount of computation, which can then be validated by other parties. Once validated, the blockchain 50 can be updated, or may remain unchanged in response to a failure to validate. The proof of work feature can be utilized to mitigate the computational cost of every device in the system having to perform the same computational functions and checks for determining a request is valid for updating the blockchain 50.

Each block can include a hash, a previous hash associated with the hash of the previous block, and data. In some implementations, each block can include a nonce. A hash can be a hash value of a fixed length that can be a fingerprint for the particular block. The hash value can be generated based on a hash function and may be changed each time a change is made to the data of that particular block. The previous hash can include a hash value of the block immediately preceding the particular block. The previous hash can be utilized to ensure the downstream ground truth stays unchanged unless proper validation occurs. The data can include transaction data (e.g., a transaction ledger), a timestamp, a value associated with a cryptocurrency value, a non-fungible token (e.g., a non-fungible token including a script that references a digital asset, nonce data, and/or general blockchain data. Nonce (i.e., a number only used once) can be a number added to a block in a blockchain that can meet a difficulty level restriction when a block is rehashed. The nonce can be a number that blockchain miners are solving for, in order to receive an incentive (e.g., cryptocurrency).

The blockchain 50 can include one or more security protocols and/or features. The blockchain 50 can include a cryptographic system. For example, the blockchain 50 can validate the blockchain 50 is valid by ensuring the stored previous hash stored in the block matches the hash value of the previous block from the last block back to the first block (e.g., the genesis block). In some implementations, the blockchain 50 can include proof of work validation that can rely on verifying proof of computation before implementing a change to the stored data (e.g., the stored ledger). Proof of work validation can take seconds, minutes, and/or hours based in part on the number of blocks in the blockchain 50. Additionally and/or alternatively, the blockchain can be implemented on a distributed, decentralized computing system. In some implementations, each computing device in the distributed, decentralized computing system can store a portion of (e.g., a block of the plurality of blocks) or all of the blocks in the blockchain Therefore, the system can verify data by ensuring the data is uniform across most, if not all, of the distributed system. Each node of the distributed system can be checked for tampering before adding new data.

The data can include data associated with a cryptocurrency value (e.g., a ledger associated with a specific cryptocurrency value), data associated with a digital asset (e.g., a non-fungible token minted on the blockchain 50 that can include a script associated with the digital asset), data associated with a smart contract (e.g., a smart contract that includes conditions that automatically initiates an action in response to a criteria being met), and/or timestamp data (e.g., timestamp data for block creation, minting, a transaction, etc.).

In particular, FIG. 1B depicts a first block 10, a second block 20, a third block 30, a fourth block 40, and an nth block 60. Although five blocks are depicted, any number of blocks can be utilized. The first block 10 can be a genesis block (e.g., a first overall block in the blockchain). The first block 10 can include a respective first hash 12 (e.g., a hash value associated with the first block 10). The first block 10 may include a first previous hash 14 (e.g., if the first block 10 has a block before it in the blockchain 50, then the hash of the previous block can be stored on the first block 10). Additionally and/or alternatively, the first block 10 can include data 16 and nonce 18.

The second block 20 can follow the first block 10. The second block 20 can include a respective second hash 22 (e.g., a hash value associated with the second block 20). The second block 20 may include a second previous hash 24 (e.g., the second previous hash 24 can be the same as, or reference, the first hash 12). Additionally and/or alternatively, the second block 20 can include data 26 and nonce 28.

The third block 30 can follow the second block 20. The third block 30 can include a respective third hash 32 (e.g., a hash value associated with the third block 30). The third block 30 may include a third previous hash 34 (e.g., the third previous hash 34 can be the same as, or reference, the second hash 22). Additionally and/or alternatively, the third block 30 can include data 36 and nonce 38.

Additionally and/or alternatively, the fourth block 40, the nth block 60, and other potential blocks can include a respective hash, a respective previous hash, and data. The first data 16, the second data 26, the third data 36, and the data of the other blocks can include overlapping data, can differ, and/or be the same such that the data is duplicative for all blocks. In some implementations, each block can be associated with a different transaction (e.g., a different minting, a different sale, etc.). The first nonce 18, the second nonce 28, the third nonce 38, and the nonce's of the other blocks can differ and may be solved during mining.

The data in each block can include ledger data, which can include a timestamp, asset and/or cryptocurrency exchanged, actors involved in transaction, and/or a variety of other information.

In some implementations, a plurality of different blockchains can be utilized for the systems and methods disclosed herein. The different blockchains can include different configurations. The different blockchains can include parallel chains, side chains, shared blocks, differing chains, varying permissions, varying purposes, varying number of blocks, and/or varying hash functions and/or varying hashing value lengths.

### Example System Arrangements

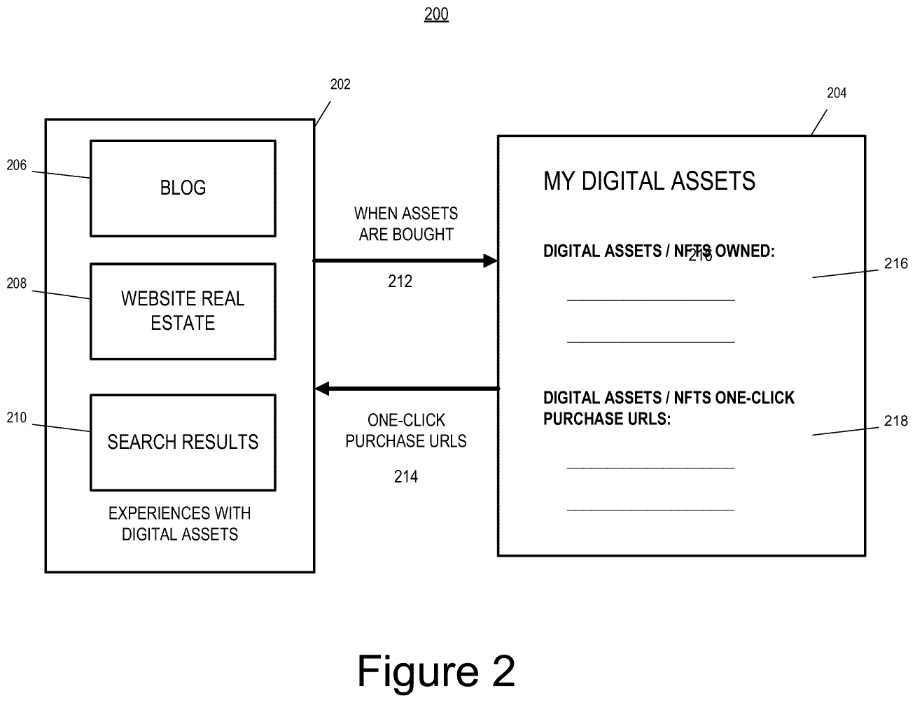

FIG. 2 depicts a block diagram of example computing system interactions 200 according to example embodiments of the present disclosure. In some implementations, the computing system interactions 200 can include experiences with digital assets 202 that can be stored and/or facilitated by server computing systems. Additionally and/or alternatively, the computing system interactions 200 can include one or more user computing systems 204 associated with digital assets owned 216 and asset one-click purchase URLs 218.

The depicted computing system interactions 200 can be included in the systems and methods disclosed herein. The experiences with digital assets 202 can include blog experiences 206, website real estate experiences 208, and/or search result experiences 210. The experiences with digital assets 202 can include providing interactive purchase elements that can be interacted with in order to trigger the purchase of a digital asset. The interactive purchase elements can be enabled by one-click purchase URLs 214 received from and/or generated for the one or more user computing systems 214. Alternatively and/or additionally, interacting with the interactive purchase element can cause a digital asset to be bought 212 by a user associated with the user computing system 204. The purchased asset can then be added to a database of digital assets owned 216 by the user. Asset one-click purchase URLs 218 may also be transferred to the user computing system for embedding in other webpages for putting the digital asset up for resale.

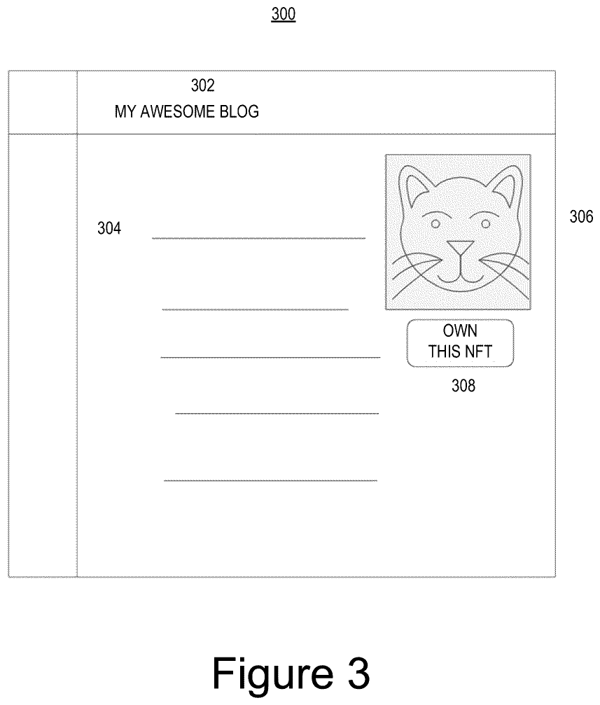

FIG. 3 depicts an illustration of an example webpage 300 according to example embodiments of the present disclosure. The example webpage 300 can include a purchase link embedded in the code of the webpage in order to generate an interactive purchase element 308. The interactive purchase element 308 can be provided for display in the user interface of the webpage 300. In some implementations, the interactive purchase element 308 can be displayed adjacent to the digital asset 306 associated with the non-fungible token up for sale. Additionally and/or alternatively, the interactive purchase element 308 can be associated with a one-click purchase link that instructs an application programming interface to add a transaction to a blockchain ledger to transfer the ownership of the non-fungible token. The webpage 300 can include a title 302 associated with the digital asset. Alternatively and/or additionally, the title 302 can be associated with a tangential topic such as the content creator. In some implementations, the webpage can include body paragraphs 304 associated with the title 302. The body paragraphs 304 can include an article, a blog post, and/or a caption for the digital asset 306. The body paragraphs 304 can provide insight on the digital asset, which can include details about the digital asset 306, details about the content creator, details about past transactions, and/or other details which can cause more informed purchase and/r can cause the surfacing of the digital asset in response to situational (or experience-based) searches.

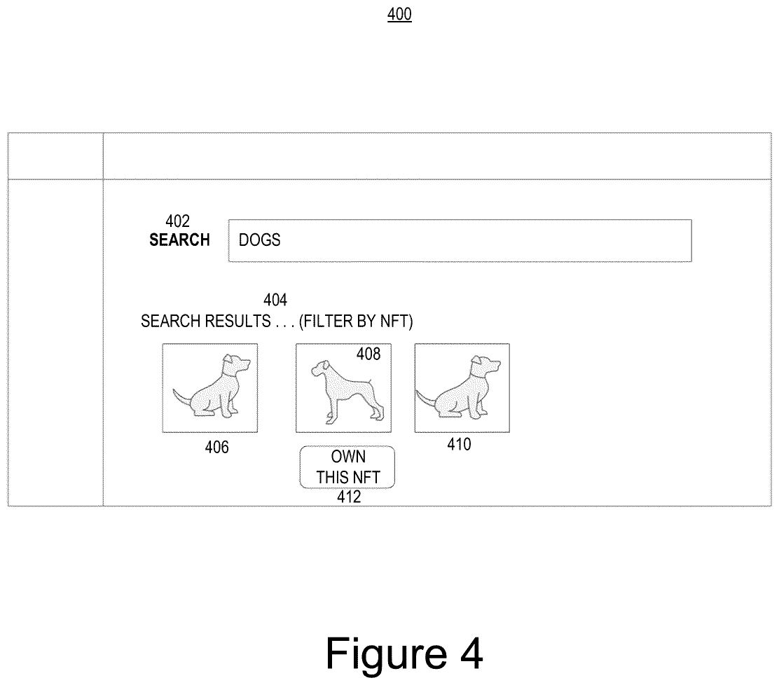

FIG. 4 depicts an illustration of an example search results page 400 according to example embodiments of the present disclosure. The example search results page 400 can include a search input field 402, search results details 404, a plurality of search results 406, 408, & 410, and/or an interactive purchase element 412 associated with one or more search results. The search input field 402 can be configured to receive one or more search terms and/or one or more input images to be processed to determine a plurality of search results. The plurality of search results can be filtered by different criteria. For example, a user may filter the search down to only search results associated with non-fungible tokens. The first search result 406, the second search result 408, and the third search result 410 can then be provided for display. In some implementations, the search results displayed can include renderings of the digital assets associated with the search results. The search results can be provided for display with interactive purchase elements 412 that can be selected to purchase a non-fungible token associated with the particular search result without leaving the search results page.

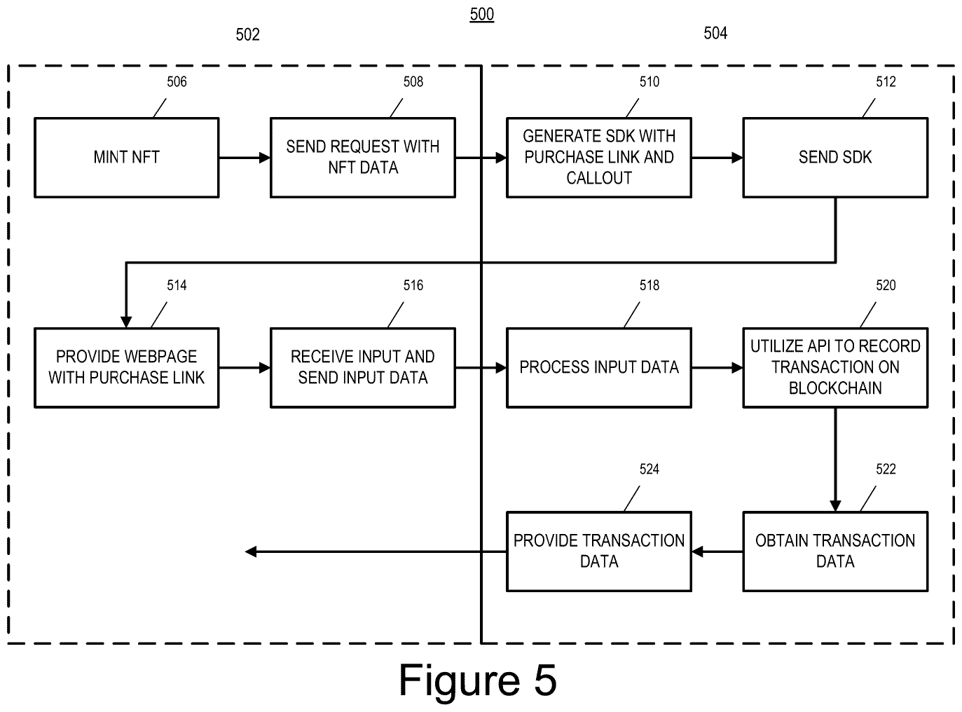

FIG. 5 depicts a block diagram of example computing system interactions 500 according to example embodiments of the present disclosure. The computing system interactions 500 can include a user computing system 502 and a server computing system 504. The user computing system 502 can mint a non-fungible token 506 on a blockchain. The user computing system can then send a request with non-fungible token data 508 to the server computing system 502. The request can be a request to receive a software packet that includes a purchase link that can be embedded into code in order to generate an interactive purchase element in a user interface. The server computing system 504 can generate a software development kit with a purchase link and callout data 510 (e.g., a software development kit that includes a software packet that includes a purchase link and callout data). The software development kit can then be sent 512 to the user computing system 502. The user computing system 502 can generate and provide a webpage with the purchase link embedded 514. The user computing system 502 and/or the server computing system 504 can receive one or more inputs and send input data 516 to the server computing system. The input data can be descriptive of a selection of the interactive purchase element. The selection can be associated with an intent to purchase the minted non-fungible token.

The server computing system 504 can process the input data 518 to determine the input data is associated with a request to complete a transaction. The server computing system 504 can then utilize an application programming interface to record the transaction on the blockchain 520. Recording the transaction can include generating proof of work and providing the proof of work to the blockchain computing system in order to add the transaction to the blockchain ledger. The server computing system 504 can then obtain transaction data 522 associated with the newly recorded transaction. The transaction data can then be provided 524 to the user computing system 502 to communicate the transfer of the asset. In some implementations, the non-fungible token and data associated with a digital asset can be transferred from a user console of a first user to a user console of a second user.

### Example Methods

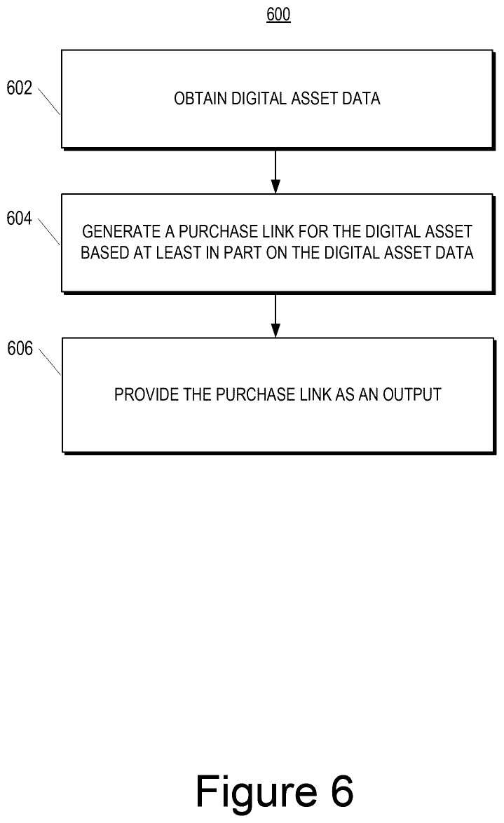

FIG. 6 depicts a flow chart diagram of an example method to perform according to example embodiments of the present disclosure. Although FIG. 6 depicts steps performed in a particular order for purposes of illustration and discussion, the methods of the present disclosure are not limited to the particularly illustrated order or arrangement. The various steps of the method 600 can be omitted, rearranged, combined, and/or adapted in various ways without deviating from the scope of the present disclosure.

At 602, a computing system can obtain digital asset data. The digital asset data can be descriptive of a digital asset and a non-fungible token for the digital asset. In some implementations, the non-fungible token can be minted on the blockchain. The digital asset can include an image, a video, audio, text data, latent encoding data, a domain, augmented-reality assets, and/or virtual-reality assets. The non-fungible token can include script data that is descriptive of a reference location for the digital asset. In some implementations, the non-fungible token can include embedded code descriptive of the digital asset. The non-fungible token can be associated with a smart contract and/or one or more electronic ledgers. The smart contract can automatically cause an action to occur in response to a triggering event. For example, currency can be exchanged in response to a transaction being recorded. The one or more electronic ledgers can record a ground truth of transaction events associated with the digital asset.

At 604, the computing system can generate a purchase link for the digital asset based at least in part on the digital asset data. The purchase link can be configured to be embedded in a webpage to enable a purchase event to occur for the digital asset within the webpage. The webpage can include one or more user interfaces and may be a blog page, a news page, a social media page, etc.

At 606, the computing system can provide the purchase link as an output. In some implementations, the purchase link can be provided in a software packet. The software packet can include script for embedding the purchase link into the webpage. The software packet can include callout data that can be recognized by a search engine. The search engine can then provide a non-fungible token indicator with the webpage's search result.

In some implementations, the computing system can generate script data. The script data can include the purchase link and callout data. Additionally and/or alternatively, the script data can be configured to be embedded in webpage code to embed the purchase link. The callout data can be discoverable by one or more search engines. In some implementations, the callout data can indicate the webpage includes a digital asset for purchase. The callout data can be configured to be processed by the one or more search engines to prompt the purchase link to be provided with a search result.

Alternatively and/or additionally, the computing system can receive input data (e.g., data descriptive of one or more selections to a user interface). The input data can be associated with a selection of the purchase link. The computing system can determine the input data is associated with a purchase request. A transaction can be recorded on a blockchain. Recording a transaction on the blockchain can include sending transaction instructions to a blockchain application programming interface to interact with a blockchain computing system associated with the blockchain.

In some implementations, the computing system can receive search input data. The search input data can include one or more search terms. A plurality of search results associated with the one or more search terms can be determined. The computing system can determine one or more particular search results of the plurality of search results are associated with one or more respective purchase links. A search results page can then be provided. The search results page can include the one or more particular search results with one or more interactive elements. In some implementations, the one or more interactive elements can be associated with the one or more respective purchase links.

Alternatively and/or additionally, the computing system can receive search input data. The search input data can include one or more input images. The computing system can determine a plurality of search results associated with the one or more input images. In some implementations, the computing system can determine one or more particular search results of the plurality of search results are associated with one or more respective purchase links. A search results page can then be provided. The search results page can include the one or more particular search results with one or more interactive elements. In some implementations, the one or more interactive elements can be associated with the one or more respective purchase links.

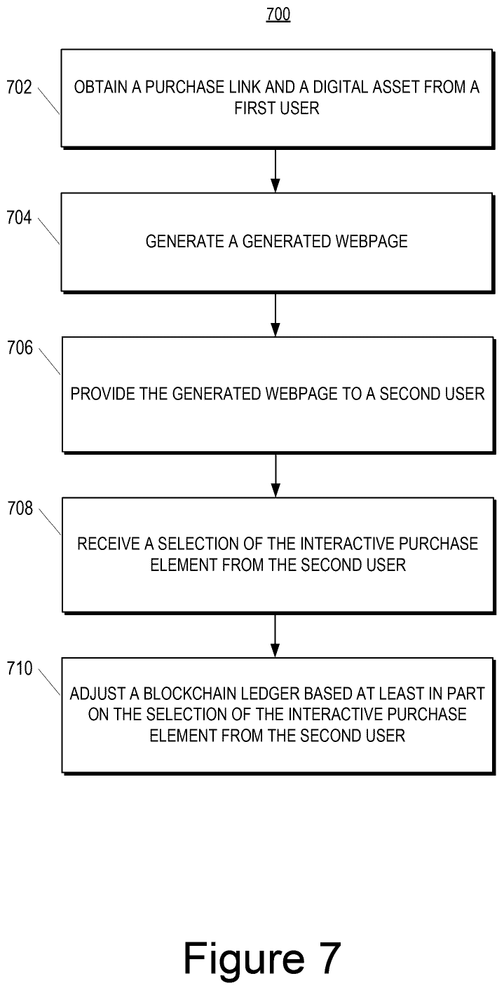

FIG. 7 depicts a flow chart diagram of an example method to perform according to example embodiments of the present disclosure. Although FIG. 7 depicts steps performed in a particular order for purposes of illustration and discussion, the methods of the present disclosure are not limited to the particularly illustrated order or arrangement. The various steps of the method 700 can be omitted, rearranged, combined, and/or adapted in various ways without deviating from the scope of the present disclosure.

At 702, a computing system can obtain a purchase link and a digital asset from a first user. The purchase link can be configured to be embedded in a webpage to enable a purchase event to occur for the digital asset within the webpage.

At 704, the computing system can generate a generated webpage. The generated webpage (e.g., a blog page, an article page, etc.) can include the digital asset and an interactive purchase element. In some implementations, the interactive purchase element can be associated with the purchase link. The digital asset can include an image. Additionally and/or alternatively, the generated webpage can include a user interface that displays the image and the interactive purchase element. The interactive element can be adjacent to the image in the user interface.

At 706, the computing system can provide the generated webpage to a second user. The generated webpage can be provided to the second user via a network. In some implementations, the generated webpage can be stored by a server computing system to be accessed by a plurality of second users via a web browser. In some implementations, the generated webpage can be provided in a user interface of a web browser application.

At 708, the computing system can receive a selection of the interactive purchase element from the second user. The selection can be determined from received input data and may be determined based on a mouse selection or touch selection proximate to an interactive purchase element displayed in the user interface.

At 710, the computing system can adjust a blockchain ledger based at least in part on the selection of the interactive purchase element from the second user. The blockchain ledger can be adjusted with one or more application programming interfaces that automatically interact with the blockchain ledger in response to the selection. In some implementations, the blockchain ledger can be associated with a blockchain computing system that stores a non-fungible token associated with the digital asset.

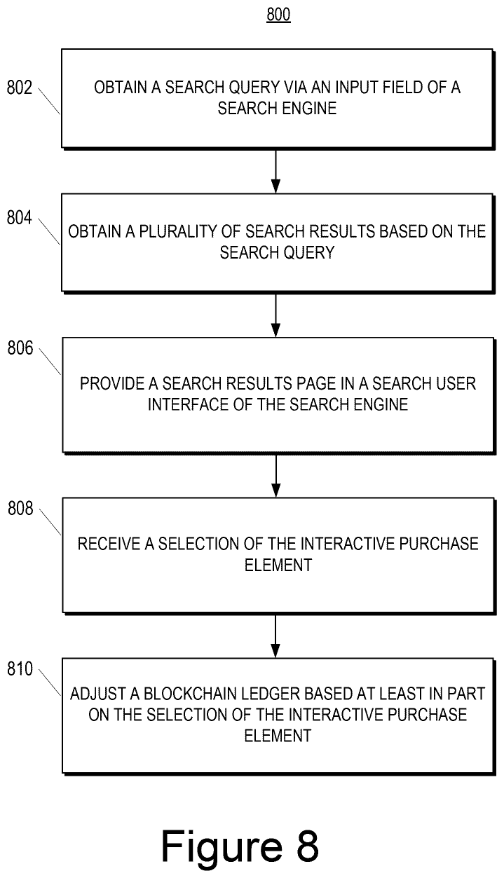

FIG. 8 depicts a flow chart diagram of an example method to perform according to example embodiments of the present disclosure. Although FIG. 8 depicts steps performed in a particular order for purposes of illustration and discussion, the methods of the present disclosure are not limited to the particularly illustrated order or arrangement. The various steps of the method 800 can be omitted, rearranged, combined, and/or adapted in various ways without deviating from the scope of the present disclosure.

At 802, a computing system can obtain a search query via an input field of a search engine. The search query can be obtained from a user computing system. The input field can include an input box in a search engine user interface.

At 804, the computing system can obtain a plurality of search results based on the search query. The plurality of search results can include one or more digital asset search results descriptive of a digital asset. In some implementations, the digital asset can be associated with a non-fungible token on a blockchain. The one or more digital asset search results can be determined based on callout data embedded into a specific webpage associated with the one or more digital asset search results.

At 806, the computing system can provide a search results page in a search user interface of the search engine. The search results page can include the one or more digital asset search results with an interactive purchase element. In some implementations, the interactive purchase element can be associated with a purchase link. The purchase link can be embedded in the search results page to enable a purchase event to occur for the digital asset within the search results page. Additionally and/or alternatively, the systems and methods can include generating the interactive purchase element based in part on the callout data. The search results page can include an image search results page. In some implementations, the image search results page can provide a plurality of image search results for display. The interactive purchase element can be provided for display adjacent to a particular image search result descriptive of the digital asset.

At 808, the computing system can receive a selection of the interactive purchase element. The selection can be determined by processing input data from the user computing system. The input data can be descriptive of the user making a touch compression proximate to the interactive purchase element.

At 810, the computing system can adjust a blockchain ledger based at least in part on the selection of the interactive purchase element. The blockchain ledger can be associated with a blockchain computing system. In some implementations, the blockchain ledger can include a plurality of blocks that are associated with a plurality of transactions associated with the digital asset.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computing system, the system comprising:
one or more processors; and
one or more non-transitory computer-readable media that collectively store instructions that, when executed by the one or more processors, cause the computing system to perform operations, the operations comprising:
obtaining digital asset data, wherein the digital asset data is descriptive of a digital asset and a non-fungible token for the digital asset;
generating a purchase link for the digital asset based at least in part on the digital asset data, wherein the purchase link is configured to be embedded in a webpage to enable a purchase event to occur for the digital asset within the webpage; and
providing the purchase link as an output.

2. The system of claim 1, wherein the operations further comprise:
generating script data, wherein the script data comprises the purchase link and callout data, wherein the script data is configured to be embedded in webpage code to embed the purchase link, and wherein the callout data is discoverable by one or more search engines.

3. The system of claim 2, wherein the callout data indicates the webpage comprises a digital asset for purchase.

4. The system of claim 2, wherein the callout data is configured to be processed by the one or more search engines to prompt the purchase link to be provided with a search result.

5. The system of claim 1, wherein the purchase link is provided in a software packet, wherein the software packet comprises script for embedding the purchase link into the webpage.

6. The system of claim 1, wherein the operations further comprise:
receiving input data, wherein the input data is associated with a selection of the purchase link;
determining the input data is associated with a purchase request;
recording a transaction on a blockchain.

7. The system of claim 6, wherein recording a transaction on the blockchain comprises:
sending transaction instructions to a blockchain application programming interface to interact with a blockchain computing system associated with the blockchain.

8. The system of claim 6, wherein the non-fungible token is minted on the blockchain.

9. The system of claim 1, wherein the operations further comprise:
receiving search input data, wherein the search input data comprises one or more search terms;
determining a plurality of search results associated with the one or more search terms;
determining one or more particular search results of the plurality of search results are associated with one or more respective purchase links; and
providing a search results page, wherein the search results page comprises the one or more particular search results with one or more interactive elements, wherein the one or more interactive elements are associated with the one or more respective purchase links.

10. The system of claim 1, wherein the operations further comprise:
receiving search input data, wherein the search input data comprises one or more input images;
determining a plurality of search results associated with the one or more input images;
determining one or more particular search results of the plurality of search results are associated with one or more respective purchase links; and
providing a search results page, wherein the search results page comprises the one or more particular search results with one or more interactive elements, wherein the one or more interactive elements are associated with the one or more respective purchase links.

11. A computer-implemented method, the method comprising:
obtaining, by a computing system comprising one or more processors, a purchase link and a digital asset from a first user, wherein the purchase link is configured to be embedded in a webpage to enable a purchase event to occur for the digital asset within the webpage;
generating, by the computing system, a generated webpage, wherein the generated webpage comprises the digital asset and an interactive purchase element, wherein the interactive purchase element is associated with the purchase link;
providing, by the computing system, the generated webpage to a second user;
receiving, by the computing system, a selection of the interactive purchase element from the second user; and
adjusting, by the computing system, a blockchain ledger based at least in part on the selection of the interactive purchase element from the second user.

12. The method of claim 11, wherein the blockchain ledger is adjusted with one or more application programming interface that automatically interacts with the blockchain ledger in response to the selection.

13. The method of claim 11, wherein the blockchain ledger is associated with a blockchain computing system that stores a non-fungible token associated with the digital asset.

14. The method of claim 11, wherein the digital asset comprises an image, and wherein the generated webpage comprises a user interface that displays the image and the interactive element.

15. The method of claim 12, wherein the interactive purchase element is adjacent to the image in the user interface.

16. One or more non-transitory computer-readable media that collectively store instructions that, when executed by one or more computing devices, cause the one or more computing devices to perform operations, the operations comprising:
obtaining a search query via an input field of a search engine;
obtaining a plurality of search results based on the search query, wherein the plurality of search results comprise one or more digital asset search results descriptive of a digital asset, wherein the digital asset is associated with a non-fungible token on a blockchain;
providing a search results page in a search user interface of the search engine, wherein the search results page comprises the one or more digital asset search results with an interactive purchase element, wherein the interactive purchase element is associated with a purchase link, wherein the purchase link is embedded in the search results page to enable a purchase event to occur for the digital asset within the search results page;
receiving a selection of the interactive purchase element; and
adjusting a blockchain ledger based at least in part on the selection of the interactive purchase element.

17. The one or more non-transitory computer-readable media of claim 16, wherein the operations further comprise:
determining the one or more digital asset search results based on callout data embedded into a specific webpage associated with the one or more digital asset search results.

18. The one or more non-transitory computer-readable media of claim 16, wherein the operations further comprise:
generating the interactive purchase element based in part on the callout data.

19. The one or more non-transitory computer-readable media of claim 16, wherein the blockchain ledger are associated with a blockchain computing system, and wherein the blockchain ledger comprises a plurality of blocks that are associated with a plurality of transactions associated with the digital asset.

20. The one or more non-transitory computer-readable media of claim 16, wherein the search results page comprises an image search results page, wherein the image search results page provides a plurality of image search results for display, and wherein the interactive purchase element is provided for display adjacent to a particular image search result descriptive of the digital asset.
